(19) United States
(12) Patent Application Publication
(10) Pub. No.: US 2007/0014271 A1
(43) Pub. Date: Jan. 18, 2007

(54) Packet Detection Device

(76) Inventor: Jyh-Ting Lai, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/381,543

(22) Filed: May 4, 2006

(30) Foreign Application Priority Data
Jul. 15, 2005 (TW) 094124212

(51) Int. Cl. H04B 7/216

(52) U.S. Cl. 370/342

(57) ABSTRACT

The present invention provides a packet detection device including a reception end for receiving signals; a matched filter coupled to the reception; a power meter coupled to the reception end and the matched filter for calculating power of signals received by the reception end; and a logic unit coupled to the matched filter and the power meter for determining whether a packet is received according to the values of the matched filter and power meter. The present invention is capable of de-spreading coefficients of a preamble sequence into first de-spread signals and second de-spread signals and determining a matched value such that the complexity and surface area of the hardware can be reduced so that the efficiency of detecting packets can be increased.

### BACKGROUND OF THE INVENTION

1. Field of the Invention

The present invention relates to a packet detection device, and more particularly, to a packet detection device capable of eliminating order coefficients of an expanded preamble sequence to reduce cost.

2. Description of the Prior Art

In recent years, wireless communication technology and devices have taken a big leap with advances in research and development. More specifically in the field of wireless personal area network (WPAN), the WPAN technique allows users to establish personal wireless transmitting spaces with a longest diameter of 10 meters. Nowadays, the two major WPAN techniques are respectively “Bluetooth” and infrared transmission. “Bluetooth” utilizes EM waves, which are hardly blocked by any obstacle, to transmit data while the infrared transmission can achieve high-speed transmission within a certain distance such as one meter. These technological advances have made obtaining information, and communication between people significantly easier and faster. For this reason, the development of wireless personal area network is commonly recognized as one of the most significant technologies of network communication.

Ultra wideband (UWB) systems for example, incorporate a multi-band orthogonal frequency division multiplexing (MB-OFDM) technology. The MB-OFDM method begins by separating a frequency spectrum into several sub-bands. Each sub-band bandwidth is 4.125 MHz. The primary advantage offered by UWB is that the average transmitted power is the same as a system designed to operate over the entire bandwidth, and information is processed over much smaller bandwidth (˜500 MHz). Thus the usage elasticity of the frequency spectrum increases, as does the compatibility with the world telecommunications, particularly with telecommunication regulations.

There are a few limitations as listed below when designing a packet detection device utilizing the MB-OFDM technology:

1. Frequency hopping: multi-band orthogonal frequency division multiplexing technology utilizes the frequency hopping method such that a frequency band utilized by a symbol is different from the frequency band utilized by a previous symbol. The protocol prevents a conventional packet detection device from accurately detecting an incoming packet. The frequency hopping method refers to the transmission end, which will switch to different carrier frequency bands to transmit signals. Therefore only a predetermined receiving end can receive signals accurately. For other receiving ends, the hopping signals generated by the frequency hopping technology are merely noise.

2. Time frequency code (TFC): To allow the receiving end to accurately receive signals, the transmission end sets the TFC at the front end of an output signal, where the signal is outputted for describing timing, and the receiving end selects various timing and frequency hopping sequences according to various TFCs.

3. Timing detection issue: when the transmission end of the MF-OFDM system utilizes a zero-padding prefix, the receiving end cannot obtain accurate timing information. This prevents the packet detection device 20 from determining a timing position of a fast Fourier transform (FFT) sampling window.

In order to solve the aforementioned problems, the prior art provides a packet detection system of a multi-band orthogonal frequency division multiplexing (MB-OFDM) system. Please refer to FIG. 1. FIG. 1 illustrates a diagram of a conventional packet detection system 100. The packet detection system 100 utilizes the MB-OFDM system. The packet detection system 100 includes a plurality of packet detection units 102, a comparison unit 104, and a packet decision module 106. An input signal X[n] is transmitted to the plurality of packet detection units 102, with each packet detection unit 102 corresponding to a TFC for determining a correlation value of the input signal X[n] and the corresponding TFC. The comparison unit 104 selects the greatest correlation value according to the plurality of correlation values determined by the packet detection unit 102, and the packet decision module 106 determines the type of the TFC and an FFT sampling window for the received packet. The packet decision module 106 then selects a frequency band and executes synchronization. Since different TFCs define various timing and frequency hopping sequences, the packet detection system 100 is capable of setting a packet detection unit 102 to correspond to various frequency codes. The packet detection system 600 can determine a TFC via the packet decision unit 102 and then determine whether a packet is received so subsequent related operations can be executed.

In the architecture of the packet detection unit 102, a TFC code, which comprises 128 coefficients, is utilized as an example. Please refer to FIG. 2. FIG. 2 illustrates a diagram of a packet detection unit 200. The packet detection unit 200 is utilized to realize the packet detection unit 102 of FIG. 1. The packet detection unit 200 comprises a series of delay units 202, a matched filter 204, a power meter 206, a mathematical squaring unit 208, and a logic unit 210. The series of delay units 202 comprises a plurality of delay units 212 (please note, in this example there are 127 delay units), each delay unit 212 is utilized for delaying signals by a clock cycle. The matched filter 204 comprises a plurality of multipliers 214 (please note, in this example there are 128 multipliers), and an addition unit 216. The multiplier 214 is utilized for executing multiplicative calculations. With the exception of the first multiplier 214, all of the remaining multipliers 214 correspond to a delay unit 212 for outputting a multiplication of an output signal from the delay unit 212 with a coefficient (C1, C2, . . . , C127) of the preamble sequence, and the first multiplier 214 outputs a multiplication of the input signal X[n] with a coefficient Ci. After computation through the addition unit 216, the output signal of the addition unit 216 is then outputted to the squaring unit 208 to produce a rational squared absolute value. The power meter 206 comprises a plurality of squaring unit 218 (please note, in this example there are 128 squaring units), and an addition unit 220. With the exception of the first squaring unit 218, all of the remaining squaring units 218 each correspond to a delay unit 212 to calculate the mathematical square of the absolute value from the output signal of the delay unit 212. Meanwhile, the first multiplier 214 calculates the mathematical square from the input signal X[n] itself, and outputs the value to the addition unit 220. The output signal of each squaring unit 218 will be added through the addition unit 220 and outputted to the logic unit 210. The logic unit 210 can comprise of a divider for calculating a correlation value of the packet according to the output signal of the squaring unit 208 and the addition unit 220.

Therefore, through the packet detection system 100 of FIG. 1, the prior art is capable of accurately detecting packets and determining the timing position of the TFC and the FFT sampling window to select a frequency band and execute synchronization. However, if each packet detection unit 102 of the packet detection system 100 utilizes the structure of the packet detection unit 200 as shown in FIG. 2, then the hardware of the packet detection system 100 will become complicated and bulky. Furthermore, the packet detection system 100 will still require a storage unit for storing the coefficients of the TFCs which causes the circuit to become even more complicated, hence increases the work load of the system and resources consumption.

In general, the conventional packet detection system sets the packet detection unit to correspond to different TFCs. Although the timing position of the TFC and the FFT sampling window can be determined accurately, due to the bulky and complicated hardware circuit, there are significant wasted resources and a decrease in the efficiency of packet detection. Therefore, an important issue for most manufacturers is how to design a simple and low cost packet detection system.

### SUMMARY OF THE INVENTION

The main objective of the claimed invention is to provide a packet detection device.

The claimed invention discloses a packet detection device for detecting packets according to a preamble sequence, the preamble sequence can be obtained by de-spreading a second de-spread signal to a first de-spread signal. The packet detection device comprises a reception end for receiving signals, a matched filter coupled to the reception end. The matched filter comprises the first de-spread unit coupled to the reception end for calculating a matched value of a first de-spread signal and the signal received by the reception end, and the second de-spread unit coupled to an output terminal of the first de-spread unit for calculating a matched value of a second de-spread signal and the signal outputted by the first de-spread unit. The packet detection device further comprises a power meter coupled to the reception end and the output terminal of the first de-spread unit for calculating a power value of the signal received by the reception end and a logic unit coupled to an output terminal of the second de-spread unit and the power meter for determining whether a packet is received according to an output signal of the second de-spread unit and the power value of the power meter.

The claimed invention further comprises a packet detection device for detecting packets according to a preamble sequence, the preamble sequence can be obtained by de-spreading a second de-spread signal to a first de-spread signal. The packet detection device comprises a reception end for receiving signals and a matched filter coupled to the reception end. The match filter comprises a preamble sequence generator for generating a preamble sequence according to the first de-spread signal and the second de-spread signal, and a matched value decision unit coupled to the reception end and the preamble sequence generator for determining a matched value of the signal received by the reception end. The packet detection device further comprises a power meter coupled to the reception end and the matched filter for calculating a power value of the signal received by the reception end, and a logic unit coupled to the matched filter and the power meter for determining whether a packet is received according to a matched value outputted by the matched filter and the power value of the power meter.

The claimed invention further discloses a packet detection device for detecting packets according to a preamble packet, the preamble sequence can be obtained by de-spreading a second de-spread signal to a first de-spread signal. The packet detection device comprises a reception end for receiving signals and a matched filter coupled to the reception end. The matched filter comprises a series of first matched value decision units coupled to the reception end comprising a plurality of first matched value decision units connected in a sequence for determining a matched degree between the signal received by the reception end and the first de-spread signal, and a series of second matched value decision units coupled to output terminals of the series of first matched value decision units comprising a plurality of second matched value decision units connected in a sequence for determining a matched degree between output signal of the first matched filter and the second de-spread signal. The packet detection device further comprises a power meter coupled to the matched filter and the power meter for calculating a power value of the signals received by the reception end, and a logic unit coupled to the matched filter and the power meter for determining whether a packet is received according to the matched value outputted by the matched filter and the power value outputted by the power meter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a diagram of a conventional packet detection system.

FIG. 2 illustrates a diagram of a packet detection unit.

FIG. 3 illustrates a diagram of a Physical Layer Convergence Procedure (PLCP) packet according to the present invention.

FIG. 4 illustrates a diagram of a de-spreading system according to the present invention.

FIG. 5 illustrates a coefficient chart of each coefficient value of a first de-spread signal corresponding to four types of preamble sequences according to the present invention.

FIG. 6 illustrates a coefficient chart of each coefficient value of a second de-spread signal corresponding to four types of preamble sequences according to the present invention.

FIG. 7 illustrates a diagram of a packet detection device according to the first embodiment of the present invention.

FIG. 8 illustrates a diagram of a packet detection device according to the second embodiment of the present invention.

FIG. 9 illustrates a detailed architecture diagram of the preamble sequence generator of FIG. 8.

FIG. 10 illustrates a detailed architecture diagram of the matched value decision unit of FIG. 8.

FIG. 11 illustrates a diagram of a power measuring system according to the present invention.

FIG. 12 illustrates a diagram of a packet detection device according the third embodiment according to the present invention.

### DETAILED DESCRIPTION

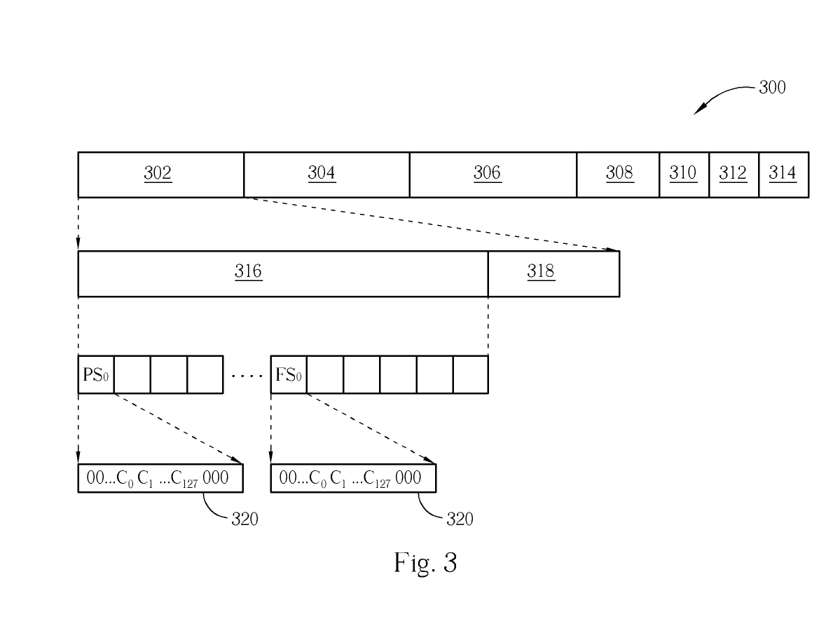

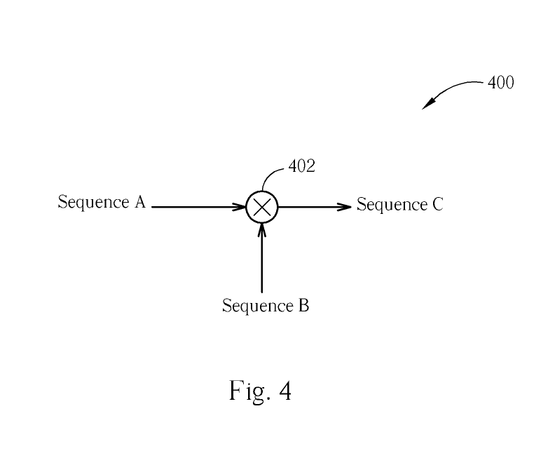

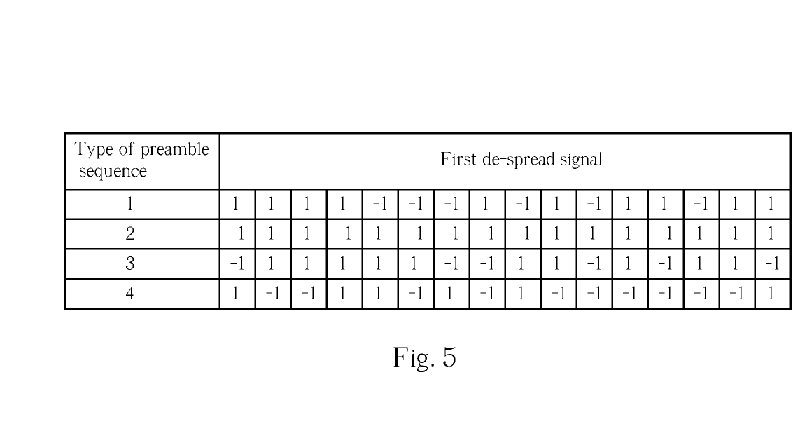

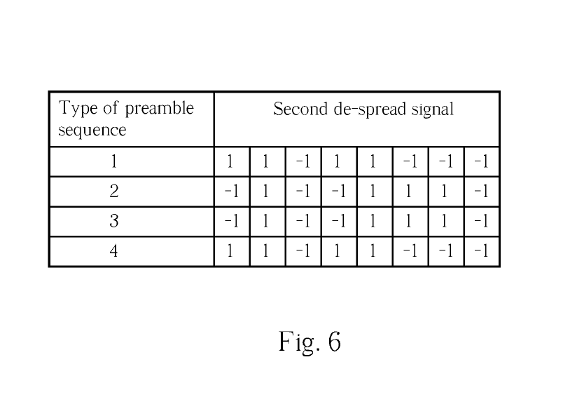

This section details an ultra wideband system that utilizes a multi-band orthogonal frequency division multiplexing technology. A packet is outputted from the transmission end, usually comprises a preamble block for defining information such as timing and band of the packet. The preamble block corresponds to a preamble sequence of a predetermined time frequency code (TFC), and the preamble block comprises a plurality of coefficients. Please refer to FIG. 3. FIG. 3 illustrates a diagram of a Physical Layer Convergence Procedure (PLCP) packet 300. The physical layer convergence procedure packet 300 comprises a preamble block 302, a header 304, an optional extension 306, a payload 308, a check 310, a tail 312, and a padding 314. Each block of the physical layer convergence procedure packet 300 is well known to those skilled in the art and therefore it does not need to be further explained. The receiving end through the preamble block 302 can perform calculations such as synchronization, recovery carrier offset, and channel estimation. The preamble block 302 can also be split into two portions: a frame synchronization sequence 316, and a channel estimation sequence 318. Both the frame synchronization sequence 316 and channel estimation sequence 318, are comprised of a plurality of smaller blocks, a block PS0 is utilized for executing packet synchronization, and a block FS0 is utilized for executing frame synchronization. Blocks PS0 and FS0 are formed by a preamble sequence 320 of a TFC comprising of a plurality of packet synchronization coefficients (C0, C1, C2, . . . , C126, C127) allowing the receiving end to select different timing and frequency hopping sequences accordingly. Therefore, the present invention is capable of detecting packets and determining time frequency sequencing according to the coefficients of different TFCs. For an ultra wideband system compliant with IEEE 802.15.3a standards, the ultra wideband system comprises four types of TFCs, each having different type of coefficient, hence generating four type of corresponding preamble sequences. The coefficient of the TFC is generated by one sequence signal de-spreading on another sequence signal to form a preamble sequence such that different TFCs can be defined. De-spreading process obtains the preamble sequence through a Walsh Hamadard multiplication algorithm. Please refer to FIG. 4. FIG. 4 illustrates a diagram of a de-spreading system 400. In FIG. 4, a sequence A (formed by a0, a1, a2 . . . a14, a15) can be viewed as 16×1 matrix, a sequence B (formed by b0, b1, b2 . . . b6, b7) can be viewed as 1×8 matrix, a sequence C (formed by C0, C1, C2 . . . C126, C127) can be obtained by multiplying the sequence A with the sequence B through a Walsh Hamadard multiplier 402. According to the definition, the four preamble sequences of the above mentioned can be obtained by de-spreading a first de-spread signal and a second de-spread signal. Please refer to FIG. 5 and FIG. 6. FIG. 5 illustrates a coefficient chart of each coefficient value of a first de-spread signal corresponding to four types of preamble sequences, and FIG. 6 illustrates a coefficient chart of each coefficient value of a second de-spread signal corresponding to four types of preamble sequences. Therefore, a hierarchical preamble sequence, for example, can be obtained by de-spreading the second de-spread signal to a first de-spread signal. Thus the original 128 coefficients can be replaced by the de-spread preamble sequence of length of 16 and the de-spread preamble sequence of length of 8, the present invention is based on the point of view of the above-mentioned.

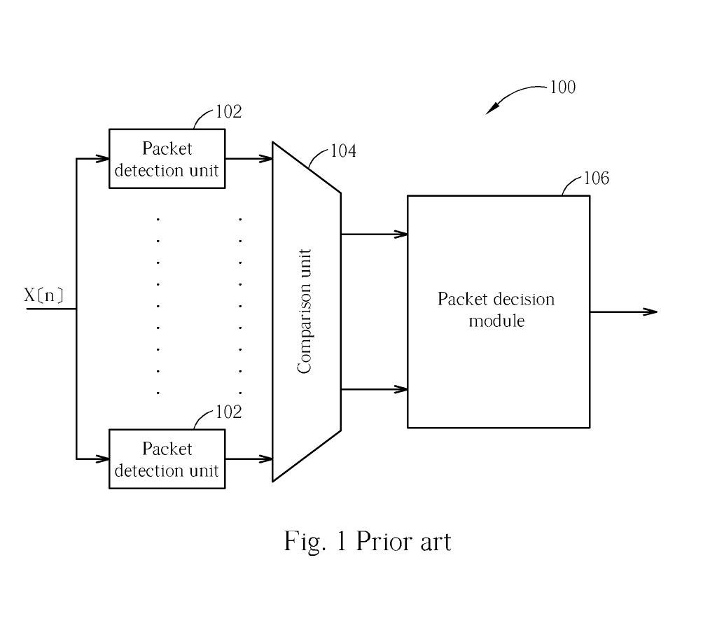

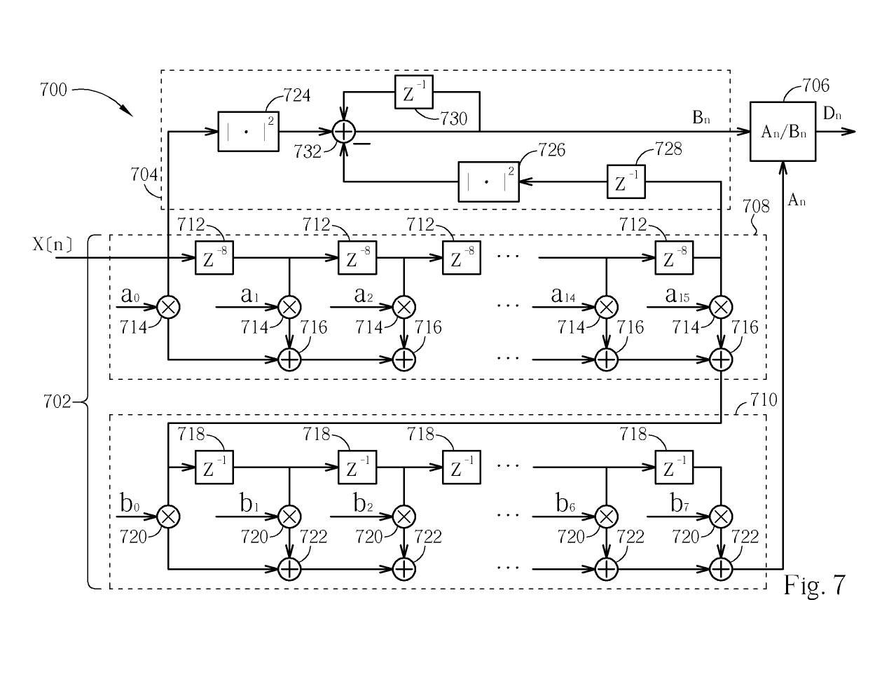

Please refer to FIG. 7. FIG. 7 illustrates a diagram of a packet detection device 700 according to the first embodiment of the present invention. The packet detection device 700 is utilized to replace the packet detection device 102 of FIG. 1, according to a preamble sequence detection packet, the hierarchical preamble sequence is obtained by de-spreading a second de-spread signal to a first de-spread signal. In the following example, the first de-spread signal comprises 16 coefficients and the second de-spread signal comprises 8 coefficients. The packet detection device 700 comprises a matched filter 702, a power meter 704, and a logic unit 706. The matched filter 702 comprises a first de-spread unit 708 and a second de-spread unit 710. In the first de-spread unit 708, a plurality of delay units 712 (in this example 15 delay units) are connected to form a delay unit sequence, each delay unit 712 is capable of delaying signals received by a plurality of unit cycles (in this example 8 unit cycles); a plurality of multipliers 714 (in this example 16 multipliers) are connected to form a multiplier sequence, each multiplier 714 is utilized for multiplying the signals received with the first de-spread signals (a0, a1, a2 . . . a14, a15), except for the first multiplier 714 which receives the input signal X[n], other multipliers 714 each corresponds to a delay unit 712 for receiving signals outputted by the delay unit 712; output signals of the plurality of multipliers 714 are accumulated and then outputted to the second de-spread unit 710 through an adder sequence formed by a plurality of adders 716. On the other hand, the architecture of the second de-spread unit 710 and the first de-spread unit 708 are similar, in the second de-spread unit 710, a plurality of delay units 718 (in this example 7 delay units) are connected to form a delay unit sequence, each delay unit 718 is capable of delaying signals received by a clock cycle; a plurality of multipliers 720 are connected to form a multiplier sequence, each multiplier 720 is utilized for multiplying the signals received with the second de-spread signals (b0, b1, b2 . . . b6, b7), except for the first multiplier 720 which receives an output signal of the last level adder 716 of the first de-spread unit 708, other multipliers 720 each corresponds to a delay unit 718 for receiving signals outputted by the delay unit 718; output signals of the plurality of multipliers 720 are accumulated and then outputted to the logic unit 706 through an adder sequence formed by a plurality of adders 722.

Otherwise, in FIG. 7, the power meter 704 comprises squarers 724, 726, delay units 728, 730 and an adder 732. The squarer 724 is capable of executing a mathematical square of the absolute value on the input signal X[n] received and outputting the result to the adder 732. The delay unit 728 is coupled to an output end of the last level delay unit 712 of the first de-spread unit 708 for delaying signals received by a clock cycle to be then transmitted to the squarer 726. The squarer 726 then performs the mathematical square of the absolute value on the output signal of the delay unit 712 and the result will then be transmitted to the adder 732. The adder 732 is utilized for subtracting the accumulated output signals of the squarer 724 and the delay unit 730, the result of the adder 732 is then inputted to the logic unit 706 and also to the delay unit 730. The logic unit 706 can comprise a divider for calculating a correlation value of a packet according to the output signals of the matched filter 702 and the power meter 704.

The following section details the operational theory of the packet detection unit 700 described above. First, a coefficient vector of the preamble sequence in the MB-OFDM is defined as the size of the FFT sampling window, which means that:
C^{H}C=N (Formula 1)

where C represents the vector of the coefficient of the preamble sequence, and N represents the size of the FFT sampling window.

At the same time, the correlation matrix of the output signal of the transmission end in the preamble must satisfy:
R_{S}=σ_{S}²CC^{H} (Formula 2)
where σ_{S}² represents the signal power.
Upon multiplication of formula 2 by C^{H} and C, the result is:
C^{H}R_{S}C=C^{H}σ_{S}²CC^{H}C [symbol]
C^{H}R_{S}C=σ_{S}²C^{H}CC^{H}C [symbol]
C^{H}R_{S}C=σ_{S}²NN=σ_{S}²N² (Formula 3)

If the received signal is the unsynchronized data, then:
R_{S}=σ_{S}²I_{N}
C^{H}R_{S}C=Nσ_{S}²

If the received signal is only noise or the unsynchronized data, then the received signal complies with:
Rₓ=σₓ²I_{N}=σₙ²I_{N}
where σₙ² is the power of White Gaussian noise.

Otherwise, the output signal of the matched filter 702 will be:
Aₙ=C^{H}X(n)X^{H}(n)C
∴Aₙ≡E[Aₙ]=C^{H}E[X(n)X^{H}(n)]C=C^{H}R_{X}(n)C

Similarly,
\tilde{B}ₙ≡E[Bₙ]=E[X(n)^{H}X(n)]=Nσₓ²

In an ideal channel, in a data period, then:
Ãₙ≡E[Aₙ]=C^{H}R_{X}(n)C=Nσₙ²

in a preamble period, then:
Ãₙ≡E[Aₙ]=C^{H}R_{X}(n)C=N²σₛ²σₕ²+Nσₙ²

therefore if an output Dn of the logic unit 706 is in the data period, then:

$${\tilde{d}}_{n} ≡ E [ {d}_{n} ] = \frac{{\tilde{A}}_{n}}{{\tilde{B}}_{n}} = \frac{N {σ}_{n}^{2}}{N {σ}_{x}^{2}} = 1$$

if in the preamble period, then:

$$\begin{matrix}{\tilde{d}}_{n} ≡ E [ {d}_{n} ] \\ = \frac{{\tilde{A}}_{n}}{{\tilde{B}}_{n}} \\ = \frac{ {N}^{ 2} {σ}_{ S}^{ 2} {σ}_{ h}^{ 2} + N {σ}_{ n}^{ 2}}{ N {σ}_{ x}^{ 2}} \\ = \frac{N {σ}_{ S}^{ 2} {σ}_{ h}^{ 2} + {σ}_{ n}^{ 2}}{ {σ}_{ x}^{ 2}} \\ = \frac{N {σ}_{ S}^{ 2} {σ}_{ h}^{ 2} + {σ}_{ n}^{ 2}}{ {σ}_{ S}^{ 2} {σ}_{ h}^{ 2} + {σ}_{ n}^{ 2}}\end{matrix}$$

(Formula 4)
as

$$\frac{{σ}_{S}^{2} {σ}_{h}^{2}}{{σ}_{n}^{2}}$$

equals to a signal to noise ratio (SNR), therefore formula 4 becomes:

$${\tilde{d}}_{n} = \frac{N \cdot SNR + 1}{SNR + 1} \qquad ( Formula 5 )$$

Inspection of formula 5 shows that when the SNR is large (σₛ²σₕ²)>>σₙ², the output of the logic unit 710 reduces to:
\tilde{d}ₙ≈N

and when the SNR is small (σₛ²σₕ²)<<σₙ², then the output of the logic unit 710 can be approximated by:
\tilde{d}ₙ≈N·SNR+1

Therefore, the output of the logic unit 706 is limited within a specific range, and the threshold value of the input signal is not affected by power. Furthermore, under a poor transmission environment (e.g., when the SNR is low), the packet detection unit 700 of the present invention can still operate normally.

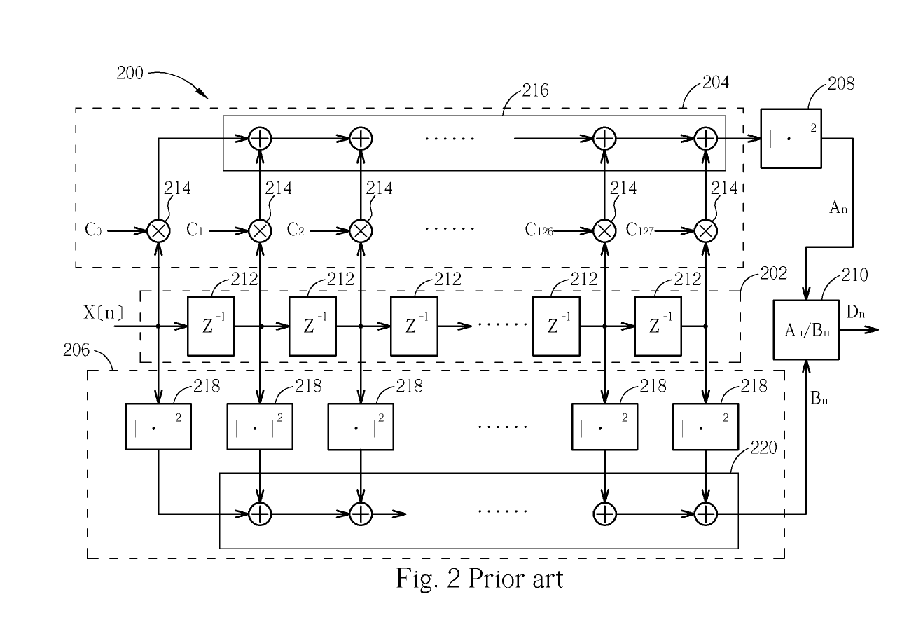

From the aforementioned, the packet detection device 700 of FIG. 7 requires the first de-spread unit 708 of a 16-level circuit architecture and the second de-spread unit 710 of an 8-level circuit architecture to complete the calculation of the matched value, the packet detection unit 200 of FIG. 2 then requires a 128 level circuit to complete the same calculation. Therefore, in comparison with the present invention, the packet detection device 700 significantly reduces the hardware requirement. Furthermore, in the present invention, the power meter 704 receives the delayed signal of 128 unit cycles outputted by the first de-spread unit 708, and hence reduces the delay units required, and the architecture of the power meter 704 is less complex than the architecture of the power meter 206.

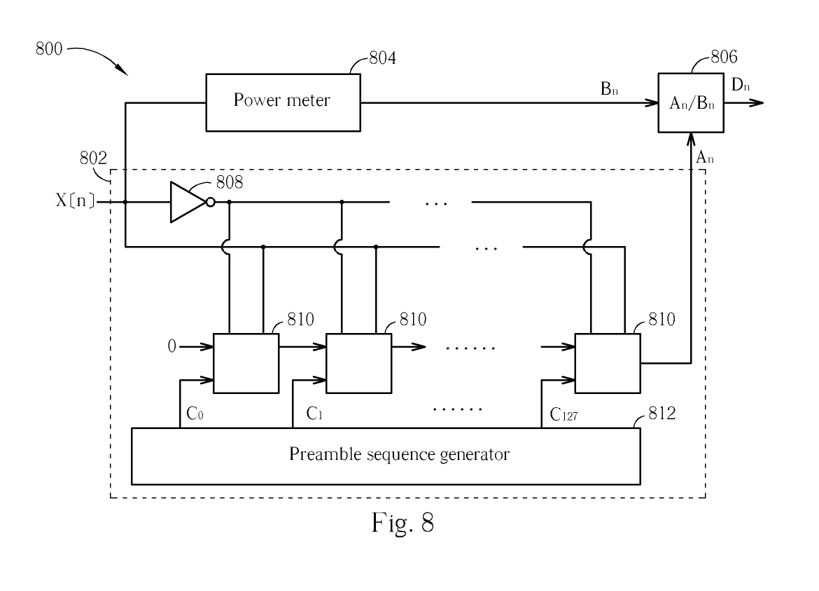

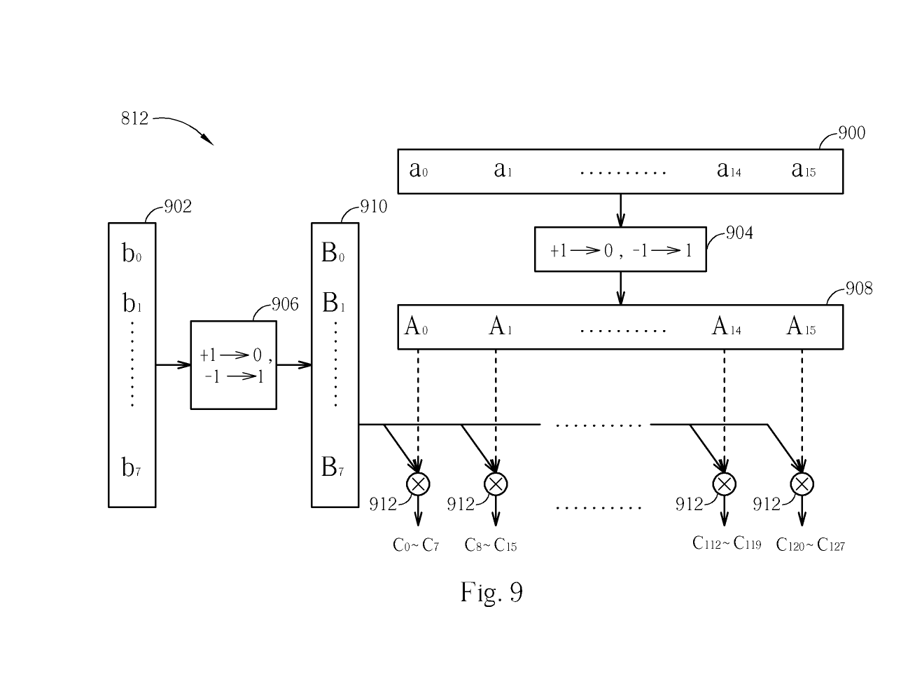

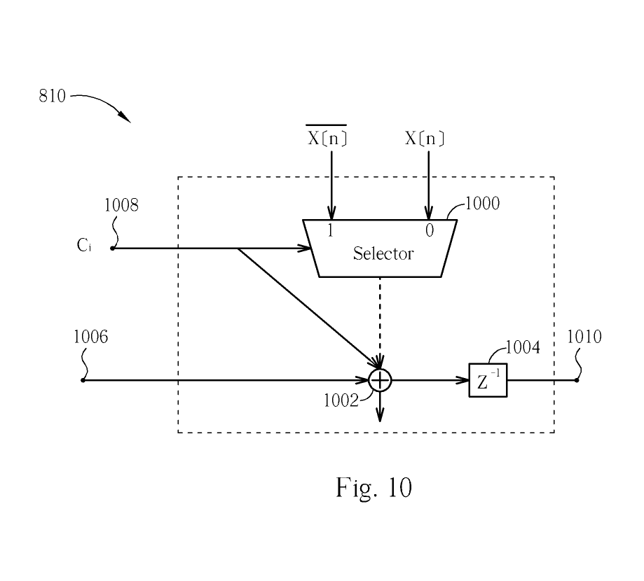

The present invention further provides a packet detection device. Please refer to FIG. 8. FIG. 8 illustrates a diagram of a packet detection device 800 according to the second embodiment of the present invention. The operational theory of the packet detection device 800 and the packet detection device 700 are similar, the packet detection device 800 also comprises a matched filter 802, a power meter 804, and a logic unit 806. However the packet detection device 800 can operate faster than the packet detection device 700 because there is no series adder as the packet detection device 700, thus the operational speed of the packet detection device 800 is faster than the operational speed of the packet detection device 700. The matched filter 802 comprises an inverter 808, a plurality of matched value decision units 810, and a hierarchical spread sequence generator 812. The inverter 808 is utilized for outputting an inverse signal of the signal X[n], the preamble sequence generator 812 is capable of generating coefficient (C0, C1, C2 . . . C126, C127). According to the input signal X[n] and its inverse signal and the coefficients (C0, C1, C2 . . . C126, C127) generated by the preamble sequence generator 812, the plurality of matched value decision units 810 is capable of outputting the matched value from the last level to the logic unit 806 to determine the type of preamble sequence of the packet. Please refer to FIG. 9. FIG. 9 illustrates a detailed architecture diagram of the preamble sequence generator 812 of FIG. 8. In the above-mentioned, the coefficients (C0, C1, C2 . . . C126, C127) of the preamble sequence can be formed from the first de-spread signals (a0, a1, a2 . . . a14, a15) and the second de-spread signals (b0, b1, b2 . . . b6, b7). Therefore, in FIG. 9, the first de-spread signals 900 (a0, a1, a2 . . . a14, a15) and the second de-spread signals 902 (b0, b1, b2 . . . b6, b7) are being converted into sequence signals 908 (A0, A1, A2 . . . A14, A15) and sequence signals 910 (B0, B1, B2 . . . B6, B7) respectively through converters 904, 906. The converters 904, 906 convert a digit 1 into a digit 0, and a digit −1 into the digit 1. The sequence signals 908, 910 further complete an exclusive-OR calculation through a plurality of multipliers 912 to obtain the coefficients C0, C1, C2 . . . C126, C127. Furthermore, please refer to FIG. 10. FIG. 10 illustrates a detailed architecture diagram of the matched value decision unit 810 of FIG. 8. The matched value decision unit 810 comprises a selector 1000, an adder 1002, and a delay unit 1004. In FIG. 10, the matched value decision unit 810 is capable of receiving the coefficients (C0, C1, C2 . . . C126, C127) outputted from the preamble sequence generator 812 through an end 1008, the matched value decision unit 810 is also capable of receiving an output signal of a previous level matched value decision unit 810 through the end 1008 and outputting the result to a next level circuit through an end 1010. The selector 1000 selects whether to output the signal X[n] or its inverse signal according to the coefficients C0, C1, C2 . . . C126, C127, the adder 1002 then accumulates and outputs the output signal of the selector 1000 and the signals received by the ends 1008, 1006 (the coefficients C0, C1, C2 . . . C126, C127 and the output signal of the previous circuit), and the output signal of the adder 1002 will be delayed for a clock cycle through the delay unit 1004 before outputting to the next level circuit through the end 1010. Therefore, the matched filter 802 is capable of outputting the matched value to the logic unit 806 to determine a correlation value. Wherein the first level matched value decision unit 810 of the matched filter 802 regards the previous level output signal as the digit 0, the last level matched value decision unit 810 of the matched filter 802 outputs the result to the logic unit 806.

From the aforementioned, the coefficients C0, C1, C2 . . . C126, C127 of the preamble sequence can be de-spread into the first de-spread signals (a0, a1, a2 . . . a14, a5) and the second de-spread signals (b0, b1, b2 . . . b6, b7), hence the hardware required can be reduced which directly lowers cost and necessary system resources. In comparison with the present invention, the conventional technology calculates the matched value according to the coefficient C0, C1, C2 . . . C126, C127 of the preamble sequence, thus the complexity of the circuit as well as cost is increased, and also a storage unit is required to store 128 coefficients. For a system that comprises a four-packet detection device, the packet detection device of the present invention can greatly reduce the resources required to achieve the objective of lowering the complexity of the circuit as well as the cost.

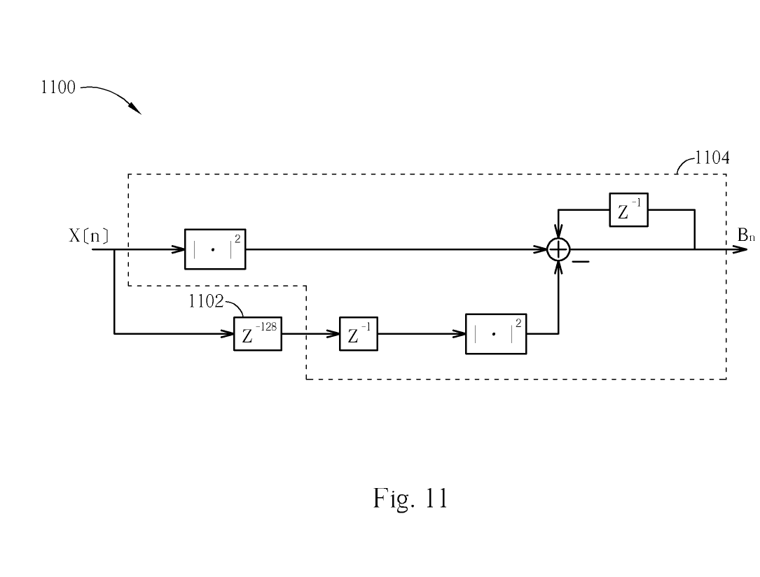

Furthermore, in FIG. 8, the power meter 804 is also capable of applying the architecture of the power meter 704 of FIG. 7. For example, please refer to FIG. 11. FIG. 11 illustrates a diagram of a power measuring system 1100. The power measuring system 1100 is utilized to realize the power meter 804 of FIG. 8, the power measuring system 1100 comprises a delay unit 1102 and a power meter 1104, the architecture of the power meter 1104 and the architecture of the power meter 704 of FIG. 7 are the same, and the delay unit 1102 is capable of delaying the input signal X[n] by a plurality of unit cycles (in this example 128 unit cycles), the delay unit 1102 replaces the plurality of delay units 712 of the first de-spread unit 708 of FIG. 7.

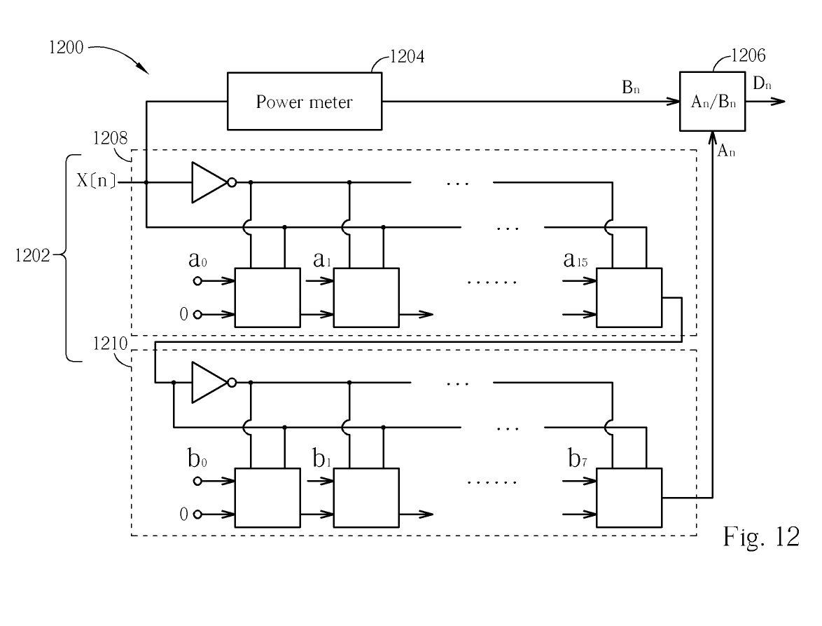

As described in the above, the coefficients C0, C1, C2 . . . C126, C127 of the preamble sequence can be de-spread into the first de-spread signals a0, a1, a2 . . . a14, a5 and the second de-spread signals b0, b1, b2 . . . b6, b7, therefore the matched filter 802 of FIG. 8 can be split into two series of matched value decision units for determining a matched value according to the first de-spread signal a0, a1, a2 . . . a14, a5 and the second de-spread signals b0, b1, b2 . . . b6, b7. Please refer to FIG. 12. FIG. 12 illustrates a diagram of a packet detection device 1200 according the third embodiment according to the present invention. The packet detection device 1200 comprises a matched filter 1202, a power meter 1204, and a logic unit 1206. The operational theory of the packet detection device 1200 is similar to the above-mentioned; therefore, it will not be reiterated. The matched filter 1202 comprises a series of first matched value decision units 1208 and a series of second matched value decision units 1210. From comparison, the architecture of the series of first matched value decision units 1208 and the series of second matched value decision units 1210 are similar to the matched filter 802 of FIG. 8. The matched filter 802 of FIG. 8 determines an input signal of a total matched value according the coefficients C0, C1, C2 . . . C126, C127 of the preamble sequence, and the series of first matched value decision units 1208 then determines the first matched value according to the first de-spread signals a0, a1, a2 . . . a14, a5; the output signal of the last level matched value decision unit of the series of first matched value decision units 1208 and through the series of second matched value decision units 1210 determines the total matched value according to the second de-spread signal b0, b1, b2 . . . b6, b7, which also means that in FIG. 12, the matched filter 1202 of the packet detection device 1200 fulfils the 128-level matched value decision unit 810 of the matched filter 802 of FIG. 8 by utilizing a 16-level series of first matched value decision units 1208 and an 8-level series of second matched value decision units 1210. The hardware required can be reduced and hence also reduces resources required by the system.

In conclusion, the present invention is capable of de-spreading the coefficients of the preamble sequence into the first de-spread signals and the second de-spread signals and determining a matched value according to the first de-spread signals and the second de-spread signals, the present invention is also capable of reducing the complexity and surface area of the hardware so that waste of resources can be reduced to increase the efficiency of detecting packets.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A packet detection device for detecting packets according to a preamble sequence, the preamble sequence obtained by de-spreading a second de-spread signal to a first de-spread signal, the packet detection device comprising:
a reception end for receiving signals;
a matched filter coupled to the reception end comprising:
a first de-spread unit coupled to the reception end for calculating a matched value of a first de-spread signal and the signal received by the reception end; and
a second de-spread unit coupled to an output terminal of the first de-spread unit for calculating a matched value of a second de-spread signal and the signal outputted by the first de-spread unit;
a power meter coupled to the reception end and the output terminal of the first de-spread unit for calculating a power value of the signal received by the reception end;
a logic unit coupled to an output terminal of the second de-spread unit and the power meter for determining whether a packet is received according to an output signal of the second de-spread unit and the power value of the power meter.

2. The packet detection device of claim 1 wherein the first de-spread unit comprises:
a series of delay units comprising a plurality of first delay units connected in a series, each first delay unit being utilized for delaying signals by a unit cycle, and a first delay unit of the plurality of first delay units being coupled to the reception end;
a plurality of first multipliers, each first multiplier comprising a first input terminal coupled to an output terminal of the first delay unit of the plurality of first delay units, and a second input terminal coupled to a coefficient of the first de-spread signal; and an addition unit coupled to each output terminal of each first multiplier for calculating and transmitting a total of output signals of the plurality of first multipliers to the power meter and the second de-spread unit.

3. The packet detection device of claim 2 wherein a first multiplier of the plurality of first multipliers comprises a first input terminal coupled to the reception end.

4. The packet detection device of claim 2 wherein multiplier coefficients of the plurality of first multipliers equal to the amount of signal counts of the first de-spread signals.

5. The packet detection device of claim 2 wherein the series of first delay units comprises a delay unit having one less signal count than the signal count of the first de-spread signals.

6. The packet detection device of claim 1 wherein the second de-spread unit comprises:
a series of second delay units comprising a plurality of second delay units connected in a sequence, each second delay unit being utilized for delaying signals by a unit cycle, and a first delay unit of the plurality of second delay units being coupled to the output terminal of the first de-spread unit;
a plurality of second multipliers, each second multiplier comprising a first input terminal coupled to an output terminal of the second delay unit of the plurality of second delay units, and a second input terminal coupled to a coefficient of the second de-spread signal; and
an addition unit coupled to each output terminal of each second multiplier for calculating and transmitting a total of output signals of the plurality of second multipliers to the logic unit.

7. The packet detection device of claim 6 wherein a first multiplier of the plurality of second multipliers comprises a first input terminal coupled to the output terminal of the first de-spread unit.

8. The packet detection device of claim 6 wherein multiplier coefficients of the plurality of second multipliers equal to the amount of signal counts of the second de-spread signals.

9. The packet decision device of claim 6 wherein the series of second delay units comprises a delay unit having one less signal count than the signal count of the second de-spread signals.

10. The packet decision device of claim 1 wherein the power meter comprises:
an adder comprising a first input terminal, a second input terminal, a third input terminal and an output terminal for subtracting signals received by the first input terminal and the second input terminal with a signal received by the third input terminal, and a calculation result being outputted to the logic unit by the output terminal;
a first squaring circuit coupled to the reception end and the first input terminal of the adder for executing an absolute square calculation on the signal received by the reception end and outputting the result to the first input terminal of the adder;
a first delay unit coupled to the first de-spread unit for delaying a unit cycle on the signal outputted by the first de-spread unit;
a second squaring circuit coupled to the first delay unit and the second input terminal of the adder for executing the absolute square calculation on the signal outputted by the first delay unit and outputting the result to the second input terminal of the adder; and
a second delay unit coupled to the output terminal of the adder and the third input terminal for delaying a unit cycle on the signal outputted by the output terminal of the adder and transmitting the signal to the third input terminal of the adder.

11. The packet detection device of claim 1 wherein the logic unit comprises a division unit for executing a division calculation on the signals outputted by the second de-spread unit and the power meter to obtain a connectivity between the output signals of the matched filter and the power meter to determine whether a packet is received.

12. The packet detection device of claim 1 being utilized in a receiving terminal of a wireless communication system.

13. The packet detection device of claim 12 wherein the wireless communication system is a multi-band orthogonal frequency division multiplexing system.

14. The packet detection device of claim 1 wherein each packet received by the reception end comprises a preamble block.

15. A packet detection device for detecting packets according to a preamble sequence, the preamble sequence can be obtained by de-spreading a second de-spread signal to a first de-spread signal, the packet detection device comprising:
a reception end for receiving signals;
a matched filter coupled to the reception end comprising:
a preamble sequence generator for generating a preamble sequence according to the first de-spread signal and the second de-spread signal; and
a matched value decision unit coupled to the reception end and the preamble sequence generator for determining a matched value of the signal received by the reception end;
a power meter coupled to the reception end and the matched filter for calculating a power value of the signal received by the reception end;
a logic unit coupled to the matched filter and the power meter for determining whether a packet is received according to a matched value outputted by the matched filter and the power value of the power meter.

16. The packet detection device of claim 15 wherein the preamble sequence generator is an exclusive OR operation circuit for executing the exclusive OR operation on each coefficient of the first de-spread signal and the second de-spread signal to obtain the preamble sequence.

17. The packet detection device of claim 15 wherein the preamble sequence generator comprises:
a converter for converting the first de-spread signal and the second de-spread signal, a positive signal being converted into a zero signal and a negative signal being converted into a positive signal; and
a plurality of multipliers for executing multiplication on each coefficient of the first de-spread signal and the second de-spread signal being converted via the converter to obtain the preamble sequence.

18. The packet detection device of claim 15 wherein the matched value decision circuit comprises a series of matched value decision units arranged in a series, each matched value decision unit comprising:
a selector for selectively outputting the signal received by the reception end or outputting an inverse signal of the signal received by the reception end;
an adder comprising a first input terminal for receiving the signal outputted by the selector, a second input terminal for receiving a signal outputted by the preamble sequence generator, a third input terminal for receiving a signal outputted by a previous matched value decision unit, and an output terminal for outputting a total output of the signals received by the first input terminal, the second input terminal and the third input terminal; and
a delay unit for delaying signals outputted by the output terminal of the adder by a unit cycle and outputting the signals to a next level matched value decision unit.

19. The packet detection device of claim 18 wherein the third input terminal of the adder of a first matched value decision unit of the matched value decision circuit receives a zero signal and a delay unit of a last matched value decision unit of the matched value decision circuit outputs signals to the logic unit.

20. The packet detection device of claim 15 wherein the power meter comprises:
an adder comprising a first input terminal, a second input terminal, a third input terminal and an output terminal for subtracting signals received by the first input terminal and the second input terminal with signals received by the third input terminal, and outputting a calculation result to the logic unit via the output terminal;
a first squaring circuit coupled to the reception end and the first input terminal of the adder for executing and outputting an absolute square calculation on the signal received by the reception end to the first input terminal of the adder;
a third delay unit coupled to the matched filter for delaying a first time on the signal outputted by the matched filter, and the first time being equal to a total cycle time of the preamble sequence;
a first delay unit coupled to the third delay unit for delaying a unit cycle on a signal outputted by the third delay unit;
a second squaring circuit coupled to the first delay unit and the second input terminal of the adder for executing the absolute square calculation on the signal outputted by the first delay unit and outputting the result to the second input terminal of the adder; and
a second delay unit coupled to the output terminal of the adder and the third input terminal for delaying a unit cycle on the signal outputted by the output terminal of the adder and transmitting the signal to the third input terminal of the adder.

21. The packet detection device of claim 15 wherein the logic unit comprises a division unit for executing a division calculation on the signals outputted by the matched filter and the power meter to obtain a connectivity between the output signals of the matched filter and the power meter to determine whether a packet is received.

22. The packet detection device of claim 15 being utilized in a receiving terminal of a wireless communication system.

23. The packet detection device of claim 22 wherein the wireless communication system is a multi-band orthogonal frequency division multiplexing system.

24. The packet detection device of claim 15 wherein each packet received by the reception end comprises a preamble block.

25. A packet detection device for detecting packets according to a preamble packet, the preamble sequence can be obtained by de-spreading a second de-spread signal to a first de-spread signal, the packet detection device comprising:
a reception end for receiving signals;
a matched filter coupled to the reception end comprising:
a series of first matched value decision units coupled to the reception end comprising a plurality of first matched value decision units connected in a series for determining a matched degree between the signal received by the reception end and the first de-spread signal; and
a series of second matched value decision units coupled to output terminals of the series of first matched value decision units comprising a plurality of second matched value decision units connected in a series for determining a matched degree between output signal of the first matched filter and the second de-spread signal;
a power meter coupled to the matched filter and the power meter for calculating a power value of the signals received by the reception end; and
a logic unit coupled to the matched filter and the power meter for determining whether a packet is received according to the matched value outputted by the matched filter and the power value outputted by the power meter.

26. The packet detection device of claim 25 wherein coefficients of the plurality of first matched value decision units are equal to signal counts of the first de-spread signals, and each first matched value decision unit comprising:
a first selector for selectively outputting the signal received by the reception end or outputting an inverse signal of the signal received by the reception end according to the first de-spread signal;
a first adder comprising a first input terminal for receiving the signal outputted by the selector, a second input terminal for receiving a coefficient of the first de-spread signal, a third input terminal for receiving a signal outputted by a previous matched value decision unit, and an output terminal for outputting a total output of the signals received by the first input terminal, the second input terminal and the third input terminal; and
a first delay unit for delaying signals outputted by the output terminal of the adder by a unit cycle and outputting the signals to a next level matched value decision unit.

27. The packet detection device of claim 26 wherein the third input terminal of the adder of a first matched value decision unit of the plurality of first matched value decision units receives a zero signal and a first delay unit of a last matched value decision unit of the plurality of first matched value decision units outputs signals to the series of second matched value decision units.

28. The packet detection device of claim 25 wherein coefficients of the plurality of second matched value decision units are equal to signal counts of the second de-spread signals, and each second matched value decision unit comprising:
a second selector for selectively outputting signals outputted by the series of first matched value decision units or outputting inverse signals of the signals outputted by the first match value decision units;
a second adder comprising a first input terminal for receiving the signal outputted by the selector, a second input terminal for receiving a coefficient of the second de-spread signal, a third input terminal for receiving a signal outputted by a previous second matched value decision unit, and an output terminal for outputting a total output of the signals received by the first input terminal, the second input terminal and the third input terminal; and
a second delay unit coupled to the output terminal of the adder and the third input terminal for delaying signals outputted by the output terminal of the adder by a unit cycle and outputting the signals to the third input terminal of the adder.

29. The packet detection device of claim 25 wherein the logic unit comprises a division unit for executing a division calculation on the signals outputted by the matched filter and the power meter to obtain a connectivity between the output signals of the matched filter and the power meter to determine whether a packet is received.

30. The packet detection device of claim 25 being utilized in a receiving terminal of a wireless communication system.

31. The packet detection device of claim 30 wherein the wireless communication system is a multi-band orthogonal frequency division multiplexing system.

32. The packet detection device of claim 25 wherein each packet received by the reception end comprises a preamble block.
